(19) United States
(12) Patent Application Publication
(10) Pub. No.: US 2018/0301276 A1
(43) Pub. Date: Oct. 18, 2018

(54) MULTIPLE WINDING INDUCTOR ASSEMBLY

(71) Applicant: MAG.LAYERS SCIENTIFIC-TECHNICS CO., LTD., TAOYUAN CITY (TW)

(72) Inventors: HSIU-FA YEH, TAOYUAN CITY (TW); PIN-YU CHEN, TAOYUAN CITY (TW); HANG-CHUN LU, TAOYUAN CITY (TW); YA-WEN YANG, TAOYUAN CITY (TW); CHIEN-CHIN CHANG, TAOYUAN CITY (TW); YU-TING HSU, TAOYUAN CITY (TW); HUNG-CHIH LIANG, TAOYUAN CITY (TW)

(21) Appl. No.: 15/489,742

(22) Filed: Apr. 18, 2017

(51) Int. Cl. H01F 27/29; H01F 37/00

(52) U.S. Cl. CPC H01F 27/29; H01F 37/005

(57) ABSTRACT

The multiple winding inductor assembly includes a first core piece, a second core piece, a first conductor, and a first core assembly. The first core assembly includes a third core piece and a second conductor. The first and second conductors, together with the first, second, and third core pieces, form multiple inductors that, when working individually, do not cause mutual inductance on those not at work, thereby avoiding energy consumption. In addition, the inductor assembly may be extended in only one direction when cascading more inductors, facilitating circuit design and layout, and the configuration of the inductor assembly on the circuit board.

### BACKGROUND OF THE INVENTION

### (a) Technical Field of the Invention

The present invention generally relates to inductors and, more particularly, to a multiple winding inductor assembly that may avoid mutual inductance and facilitate circuit design and layout.

### (b) Description of the Prior Art

Inductors are commonly applied in electronic circuits for current choke, rectification, energy storage, oscillation, phase delay, or transformer. As electronic appliance are getting smaller with more functions, there are teachings about an inductor assembly having multiple windings functioning as multiple inductors. For example, R.O.C. Taiwan Patent No. M535865 teaches a mutual-inductance-free inductor assembly with multiple windings. As shown in FIG. 5 of M535865's drawings, the inductor includes a first piece, a second core piece, a middle piece, a first conductor, and a second conductor.

FIG. 1 of the present disclosure is a perspective diagram showing the inductor assembly of M535865 after its assembly from the components described above. As illustrated, the inductor assembly may involve multiple inductors cascade laterally from the middle piece 15. In other words, the first core piece 11, the first conductor 12, the second core piece 13, and the second conductor 14 may be repeatedly configured and cascaded. The inductor assembly will later be attached to a circuit board through such as SMD. For this kind of inductor assemblies that may extend in two directions, special attention is required to the design and layout of the circuit board, especially to the lateral sides to the middle piece 15. The SMD would also be more difficult, therefore leading to lower process speed and more complicated movement of fixtures or robotic arms.

In addition, first and second gaps 100 and 200 are formed between the middle piece 15 and the first core piece 11, and the second core piece 13. The contact terminals 300 and 400 of the first and second conductors 12 and 14 are located to the lateral sides of the middle piece 15, respectively. As such, during the process of configuring the inductor assembly on the circuit board, the configuration accuracy becomes an issue (when the adaptability of fixtures and robotic arms is not taken into consideration).

### SUMMARY OF THE INVENTION

To obviate the shortcomings of the prior art, an objective of the present invention is to provide a multiple winding inductor assembly that may avoid mutual inductance among multiple inductors and facilitate the design and layout of the circuit board.

The multiple winding inductor assembly includes a first core piece having a first major face and a second major face, and a second core piece having a third major face and a fourth major face. The second core piece has a first indentation on the third major face and a first column housed in the first indentation. The first indentation's two walls have a first gap and a second gap, respectively, at their bottom ends. The inductor assembly further includes a first conductor including a first lateral section, and a first vertical section and a second vertical section extended downward from the first lateral section's two ends. A bottom end of the first vertical section is bended perpendicularly outward into a first foot, and a bottom end of the second vertical section is bended perpendicularly outward into a second foot. The first conductor is embedded in the first indentation and surrounds the first column with the first and second feet received by the first and second gaps, respectively. The inductor assembly further includes a first core assembly including a third core piece and a second conductor. The third core piece has a fifth major face and a sixth major face. The third core piece has a second indentation on the fifth major face and a second column housed in the second indentation. The second indentation's two walls have a third gap and a fourth gap, respectively, at their bottom ends. The second conductor includes a second lateral section, and a third vertical section and a fourth vertical section extended downward from the second lateral section's two ends. A bottom end of the third vertical section is bended perpendicularly outward into a third foot, and a bottom end of the fourth vertical section is bended perpendicularly outward into a fourth foot. The second conductor is embedded in the second indentation and surrounds the second column with the third and fourth feet received by the third and fourth gaps, respectively. The second major face is joined to the third major face, and the fourth major face is joined to the fifth major face.

The first, second, third, and fourth feet are further bended perpendicularly downward to form seventh, eighth, ninth, and tenth feet.

The multiple winding inductor assembly further includes a second core assembly, including a fourth core piece and a third conductor. The fourth core piece has a ninth major face and a tenth major face. The fourth core piece has a third indentation on the ninth major face and a third column housed in the third indentation. The third indentation's two walls have a fifth gap and a sixth gap, respectively, at their bottom ends. The third conductor includes a third lateral section, and a fifth vertical section and a sixth vertical section extended downward from the third lateral section's two ends. A bottom end of the fifth vertical section is bended perpendicularly outward into a fifth foot, and a bottom end of the sixth vertical section is bended perpendicularly outward into a sixth foot. The third conductor is embedded in the third indentation and surrounds the third column with the fifth and sixth feet received by the fifth and sixth gaps, respectively. The fourth major face is attached to the ninth major face, and the sixth major face is joined to the ninth major face.

The fifth and sixth feet are further bended perpendicularly downward to form eleventh and twelfth feet.

As described above, the first and second conductors, together with the first, second, and third core pieces, form multiple inductors that, when working individually, do not cause mutual inductance on those not at work, thereby avoiding energy consumption. In addition, the inductor assembly may be extended in only one direction when cascading more inductors, facilitating circuit design and layout, and the configuration of the inductor assembly on the circuit board.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a multiple winding inductor assembly according to prior art.

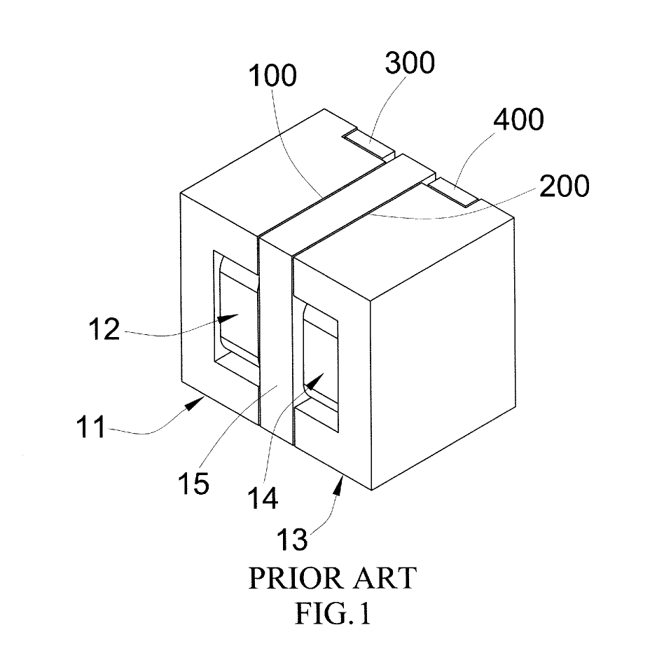

FIG. 2 is a perspective break-down diagram showing a multiple winding inductor assembly according to a first embodiment of the present invention.

FIG. 3 is a perspective diagram showing the inductor assembly of FIG. 2 after assembly.

FIG. 4 is a schematic diagram showing magnetic flux paths of the inductor assembly of FIG. 2.

FIG. 5 is a perspective break-down diagram showing a multiple winding inductor assembly according to a second embodiment of the present invention.

FIG. 6 is a perspective diagram showing an inductor assembly according to the present invention configured on a circuit board.

FIG. 6A is a perspective break-down diagram showing a multiple winding inductor assembly according to a third embodiment of the present invention.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

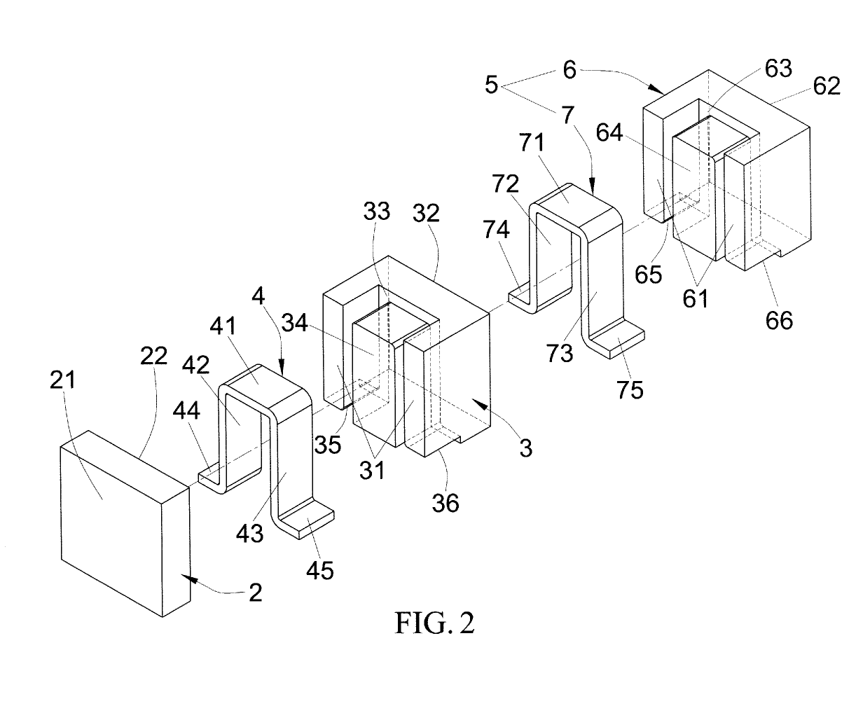

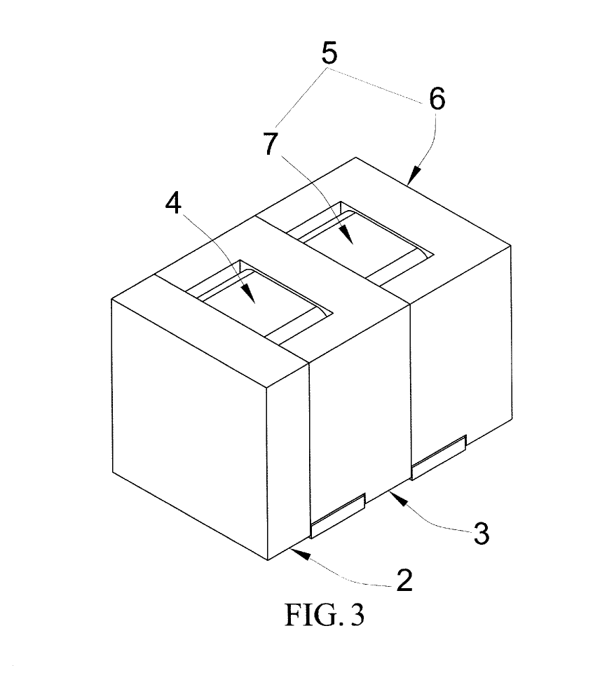

As shown in FIGS. 2 and 3, a multiple winding inductor assembly according to an embodiment of the present invention includes a first core piece 2, a second core piece 3, a first conductor 4, and a first core assembly 5.

The first core piece has a first major face 21 and a second major face 22. The second core piece 3 has a third major face 31 and a fourth major face 32. The second core piece 3 has a first indentation 33 on the third major face 31, and a first column 34 housed in the first indentation 33. The first indentation 33's two walls have their bottom ends not aligned with the first column 34, but reserve a first gap 35 and a second gap 36, respectively. The second core piece 3, therefore, has an E-like shape but is not limited as such. The first conductor 4 includes a first lateral section 41, and a first vertical section 42 and a second vertical section 43 extended downward from the first lateral section 41's two ends. The first lateral section 41, the first and second vertical sections 42 and 43 jointly form a U-like shape but is not limited as such. A bottom end of the first vertical section 42 is bended perpendicularly outward into a first foot 44. A bottom end of the second vertical section 43 is bended perpendicularly outward into a second foot 45. The first conductor 4 is embedded in the first indentation 33 and surrounds the first column 34 with the first and second feet 44 and 45 received by the first and second gaps 35 and 36, respectively.

The first core assembly 5 includes a third core piece 6 and a second conductor 7. The third core piece 6 has a fifth major face 61 and a sixth major face 62. The third core piece 6 has a second indentation 63 on the fifth major face 61, and a second column 64 housed in the second indentation 63. The second indentation 63's two walls have their bottom ends not aligned with the second column 64, but reserve a third gap 65 and a fourth gap 66, respectively. The third core piece 6, therefore, has an E-like shape but is not limited as such. The second conductor 7 includes a second lateral section 71, and a third vertical section 72 and a fourth vertical section 73 extended downward from the second lateral section 71's two ends. The second lateral section 71, the third and fourth vertical sections 72 and 73 jointly form a U-like shape but is not limited as such. A bottom end of the third vertical section 72 is bended perpendicularly outward into a third foot 74. A bottom end of the fourth vertical section 73 is bended perpendicularly outward into a fourth foot 75. The second conductor 7 is embedded in the second indentation 63 and surrounds the second column 64 with the third and fourth feet 74 and 75 received by the third and fourth gaps 65 and 66, respectively. The first core piece 2, second core piece 3, first conductor 4, and first core assembly 5 are joined together where the second major face 22 is attached to the third major face 31, the fourth major face 32 is attached to the fifth major face 61, and adhesive is used to bind them together. The adhesive may be one of a thermosetting adhesive, a thermoplastic adhesive, and a silicone adhesive, but is not limited as such.

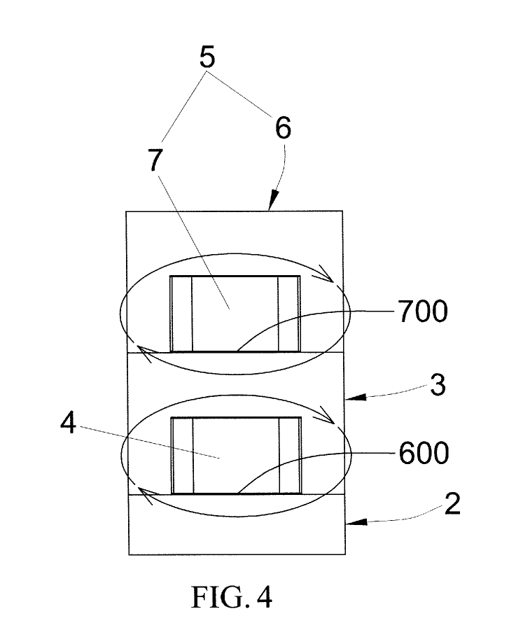

As shown in FIG. 4, closed magnetic flux paths and gaps 600 and 700 are respectively formed between the first and second core pieces 2 and 3, and between the second and third core pieces 3 and 6. According to magnetic induction, when one of the windings (e.g., the first core piece 2, the first conductor 4, and the second core piece 3) is off and the other winding (e.g., the second core piece 3, the second conductor 7, and the third core piece 6) is on, no mutual inductance would occur or the mutual inductance (Lm) is close to zero (percentage), meaning that no energy would be transferred from one inductor when it works to the other, and the other inductor would not produce induced voltage. As such, when multiple inductors operate independently, there is no energy consumption from mutual induction, and the multiple inductors would maintain their normal function and performance.

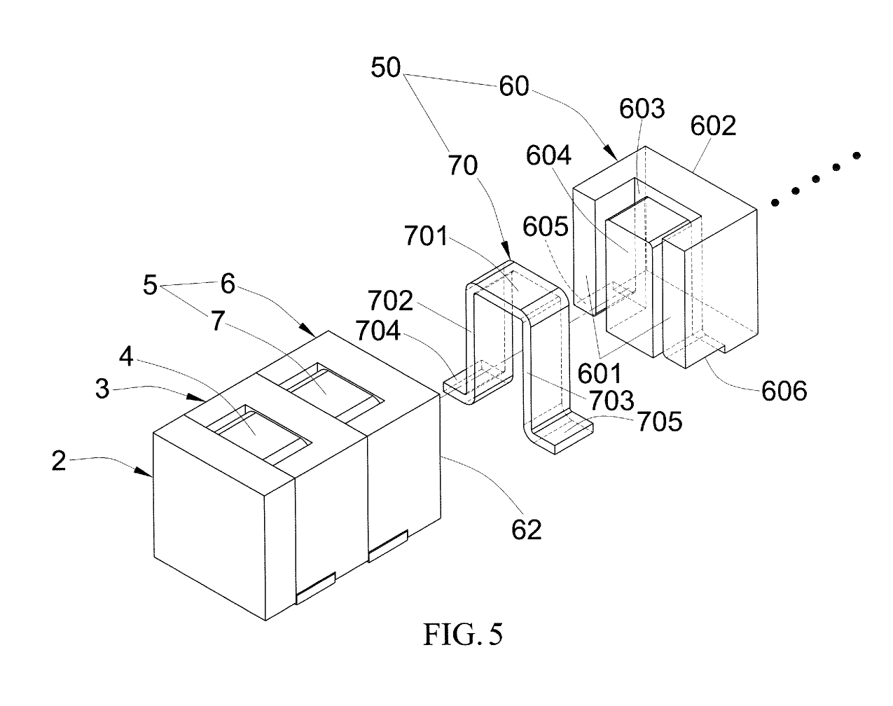

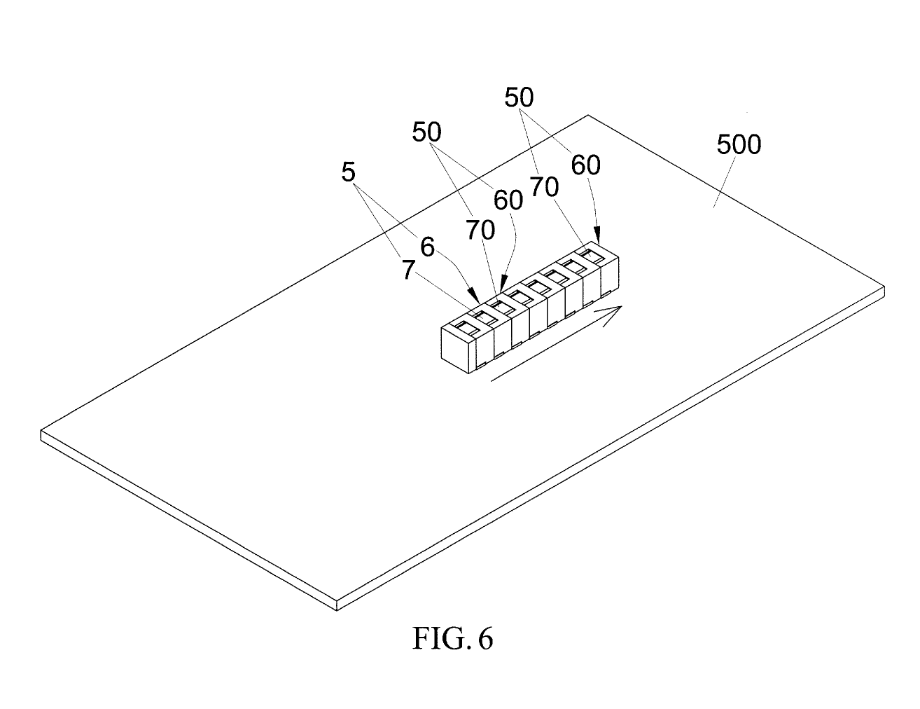

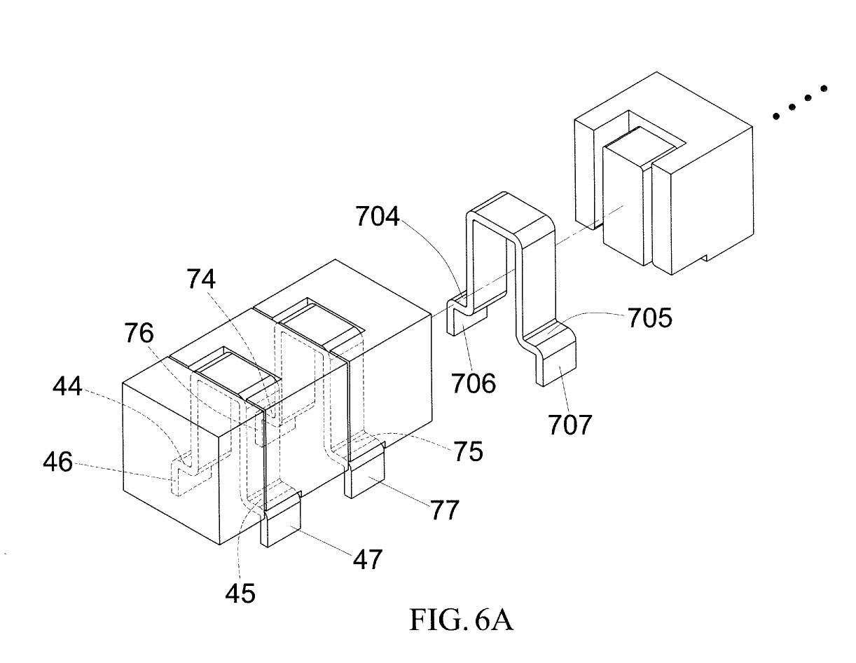

As shown in FIGS. 5 and 6, in addition to the two-inductor assembly formed by the first core piece 2, the second core piece 3, the first conductor 4, the first core assembly 5, at least an additional second core assembly 50 may be laterally cascaded to the first core assembly 5, thereby forming a multiple winding inductor assembly having more than two inductors. The second core assembly 50 includes a fourth core piece 60 and a third conductor 70. The fourth core piece 60 has a ninth major face 601 and a tenth major face 602. The fourth core piece 60 has a third indentation 603 on the ninth major face 601, and a third column 604 housed in the third indentation 603. The third indentation 603's two walls have their bottom ends not aligned with the third column 604, but reserve a fifth gap 605 and a sixth gap 606, respectively. The fourth core piece 60, therefore, has an E-like shape but is not limited as such. The third conductor 70 includes a third lateral section 701, and a fifth vertical section 702 and a sixth vertical section 703 extended downward from the third lateral section 701's two ends. A bottom end of the fifth vertical section 702 is bended perpendicularly outward into a fifth foot 704. A bottom end of the sixth vertical section 703 is bended perpendicularly outward into a sixth foot 705. The third conductor 70 is embedded in the third indentation 603 and surrounds the third column 604 with the fifth and sixth feet 704 and 705 received by the fifth and sixth gaps 605 and 606, respectively. The first core piece 2, second core piece 3, first conductor 4, and second core assembly 5 are joined together where the second major face 22 is attached to the third major face 31, the fourth major face 32 is attached to the ninth major face 601, and adhesive is used to bind them together. The adhesive may be one of a thermosetting adhesive, a thermoplastic adhesive, and a silicone adhesive, but is not limited as such. The sixth major face 62 is joined to the ninth major face 601.

In contrast to the prior art, the present embodiment has the second core piece 3, the first conductor 4, the first core assembly 5, and the second core assembly 50 cascaded in one direction, not two opposite directions, thereby maintaining identical gaps between the inductors. In addition, the present invention is able to have one gap less than the prior art, achieving greater space efficiency. As shown in FIG. 6, when an inductor assembly according to the present invention is to be placed on a circuit board 500, the design and layout effort may be reduced as only one direction (indicated by the arrow) has to be taken into consideration. Regardless how many inductors are configured by cascading even more second core assembly 50, their independent or concurrent operation does not suffer from mutual induction and would maintain their normal functions.

Furthermore, as the terminals of the multiple inductors provided by the multiple winding inductor assembly are more regularly arranged, when the inductor assembly is to be configured on the circuit board 500 by SMD, a more accurate configuration may be achieved, and fixtures or robotic arms are not required to perform complex operation, achieving enhanced installation convenience.

In summary, as shown in FIGS. 5 and 6, a multiple winding inductor assembly is formed by integrating the first conductor 4 and the second conductor 7, together with the first core piece 2, the second core piece 3, and third core piece 6, or by additionally configuring one or more the second core assembly 50. The multiple inductors function independently with causing energy consumption resulted from mutual induction. In addition, as the multiple winding inductor assembly is cascaded and extended in one direction, the design and layout of circuit board 500 is more flexible and convenient, and the configuration of the multiple winding inductor assembly on the circuit board 500 is more accurate and simplified.

As shown in FIG. 6A, the first foot 44 is further bended perpendicularly downward to form a seventh foot 46. Similarly, the second, third, fourth, fifth, and sixth feet 45, 74, 75, 704, and 705 are bended perpendicularly downward to form eighth, ninth, tenth, eleventh, and twelfth feet 47, 76, 77, 706, and 707. By these feet 46, 47, 76, 77, 706, and 707, the multiple winding inductor assembly may be raised above the circuit board so that space is provided beneath for accommodating other electronic components, effectively enhancing the estate efficiency.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A multiple winding inductor assembly, comprising:
a first core piece having a first major face and a second major face;
a second core piece having a third major face and a fourth major face, where the second core piece has a first indentation on the third major face and a first column housed in the first indentation, the first indentation's two walls have a first gap and a second gap, respectively, at their bottom ends;
a first conductor comprising a first lateral section, and a first vertical section and a second vertical section extended downward from the first lateral section's two ends, where a bottom end of the first vertical section is bended perpendicularly outward into a first foot, a bottom end of the second vertical section is bended perpendicularly outward into a second foot, the first conductor is embedded in the first indentation and surrounds the first column with the first and second feet received by the first and second gaps, respectively; and
a first core assembly, comprising a third core piece and a second conductor, where the third core piece has a fifth major face and a sixth major face, the third core piece has a second indentation on the fifth major face and a second column housed in the second indentation, the second indentation's two walls have a third gap and a fourth gap, respectively, at their bottom ends, the second conductor comprises a second lateral section, and a third vertical section and a fourth vertical section extended downward from the second lateral section's two ends, a bottom end of the third vertical section is bended perpendicularly outward into a third foot, a bottom end of the fourth vertical section is bended perpendicularly outward into a fourth foot, the second conductor is embedded in the second indentation and surrounds the second column with the third and fourth feet received by the third and fourth gaps, respectively;
wherein the second major face is joined to the third major face; and
the fourth major face is joined to the fifth major face.

2. The multiple winding inductor assembly according to claim 1, wherein the first, second, third, and fourth feet are further bended perpendicularly downward to form a seventh, eighth, ninth, and tenth feet.

3. The multiple winding inductor assembly according to claim 1, further comprising a second core assembly, where the second core assembly comprises a fourth core piece and a third conductor; the fourth core piece has a ninth major face and a tenth major face; the fourth core piece has a third indentation on the ninth major face and a third column housed in the third indentation; the third indentation's two walls have a fifth gap and a sixth gap, respectively, at their bottom ends; the third conductor comprises a third lateral section, and a fifth vertical section and a sixth vertical section extended downward from the third lateral section's two ends; a bottom end of the fifth vertical section is bended perpendicularly outward into a fifth foot; a bottom end of the sixth vertical section is bended perpendicularly outward into a sixth foot; the third conductor is embedded in the third indentation and surrounds the third column with the fifth and sixth feet received by the fifth and sixth gaps, respectively; the fourth major face is attached to the ninth major face; and the sixth major face is joined to the ninth major face.

4. The multiple winding inductor assembly according to claim 3, wherein the fifth and sixth feet are further bended perpendicularly downward to form eleventh and twelfth feet.
